(19) United States
(12) Patent Application Publication
(10) Pub. No.: US 2010/0332577 A1
(43) Pub. Date: Dec. 30, 2010

(54) METHOD AND DEVICE FOR IMPROVING THE PASSBAND OF A PHYSICAL SYSTEM

(75) Inventors: Michel Ayraud, Voreppe (FR); Nathalie Pascal, Le Sappey En Chartreuse (FR)

Correspondence Address: LOWE HAUPTMAN HAM & BERNER, LLP, 1700 DIAGONAL ROAD, SUITE 300, ALEXANDRIA, VA, 22314, US

(73) Assignee: E2V SEMICONDUCTORS, SAINT EGREVE (FR)

(21) Appl. No.: 12/918,337

(22) PCT Filed: Feb. 9, 2009
(86) PCT No.: PCT/EP2009/051424

§ 371 Date: Aug. 19, 2010

(30) Foreign Application Priority Data
Feb. 19, 2008 (FR) 0800885

(51) Int. Cl. G06F 17/17; G06F 17/10

(52) U.S. Cl. 708/313; 708/300

(57) ABSTRACT

The invention relates to the improvement of the passband of physical systems. Use is made of a finite impulse response filter which is calculated in the following manner, on the basis of the behavior (observed or known) of the physical system: the impulse response a(t) of the physical system according to a temporal or spatial variable is determined; an impulse response b(t) of similar form but compressed according to the scale of the variable t in a ratio n and expanded in amplitude in the same ratio is calculated sample by sample, and the coefficients of a finite impulse response filter able to provide at its output the signal b(t) when the signal a(t) is applied to its input are calculated. This finite impulse response filter is incorporated into the physical system, preferably at the output, so as to improve the passband thereof in the ratio n.

### RELATED APPLICATIONS

The present application is based on International Application Number PCT/EP2009/051424, filed Feb. 9, 2009, and claims priority from French Application Number 0800885, filed Feb. 19, 2008, the disclosures of which are hereby incorporated by reference herein in their entirety.

### FIELD OF THE INVENTION

The invention relates to a method and an electronic circuit for improving the passband of a device which, for physical reasons, possesses a smaller passband than that which would be desired.

### BACKGROUND OF THE INVENTION

It is known that any electronic system produced on the basis of physical elements possesses a limited passband due to the non-ideal characteristics of the system. This is the case in particular for all systems for the electronic acquisition of physical quantities (sensors) but also for all systems for processing electronic signals or for transmitting electronic or optical signals.

As a result of this limit of non-ideal systems, any physical system behaves, in relation to an input quantity, as a filter which is in general a low-pass filter, but which could be more sophisticated than a simple low-pass filter. This is manifested in practice by the fact that the output of the system does not succeed in following the overly rapid variations of an input quantity of the system. When speaking here of variation, this may be especially a temporal variation but also a spatial variation.

For example, for an image sensor, the input variation may be a temporal variation of light and the output variation is a temporal variation of electric voltage which represents this variation of light; it is thus appreciated that, merely from the fact that the sensor is a sensor produced on the basis of physical elements (photodiodes, circuits for gathering electrical charges, amplifiers, transmission circuits, etc), the electronic signal cannot instantaneously follow a very abrupt variation of light at the input; the response of the sensor includes a low-pass temporal filtering function. Likewise, if a matrix sensor comprising numerous very closely spaced pixels is considered, illuminated by a very fine spatial image pattern, it is appreciated that the sensor cannot engender an electronic signal that varies spatially as abruptly as the image pattern which illuminates it; here again the sensor produces a certain filtering function, but this time in the spatial domain and therefore as a function of a spatial variable. The passband in the spatial domain may be as significant as in the temporal domain and the correction principles according to the present invention apply in both cases.

To analyze the behavior of the sensor both in terms of temporal response and spatial response, it is possible to try to determine its temporal or spatial transfer function. Several sorts of transfer function, using time or frequency variables, or else the Laplace variable p of analog systems or the z variable of sampled systems, are conventionally used to represent transfer functions of physical systems.

When it is known that a physical system exhibits a frequency-limited transfer function, it is known that the overall response of the system can be improved by including in the latter an inverse filter which tends to compensate the system's natural filtering function. Thus, if the system acts as low-pass temporal filter, this almost always being the case, a high-pass filter which tends to compensate the low-pass filtering effect that was identified previously can be incorporated into it.

If the low-pass filtering function of the physical system is known, then one tries in this case to produce an analog or digital filter which possesses an almost inverse filtering function. The sophisticated filtering functions which result therefrom in general are very difficult to produce in an analog manner; they can scarcely be executed other than by calculation and by using powerful processors. It is for example possible to determine the transfer function of the physical system in the frequency space through a Fourier transformation; this transformation establishes a response curve in the frequency domain. Next, the inverse filtering function is calculated; in the frequency domain the inverse function is quite simply the inverse of the initial transfer function of the physical system. While the system is in use, a Fourier transformation is applied to the output signal of the physical system to define components in the frequency domain, the inverse filtering function is applied to it in the frequency domain, and the temporal domain is returned to through an inverse Fourier transformation to obtain a filtered temporal electronic signal, having a better passband than that of the uncorrected physical system. This type of method requires very high calculation powers to perform the Fourier transform and the inverse transform at each instant.

### SUMMARY OF THE INVENTION

The invention proposes a much simpler solution for increasing the passband of a physical system. In this solution, use is made of a finite impulse response filter which is calculated in the following manner, on the basis of the behavior (observed or known) of the physical system: the impulse response of the physical system according to a temporal or spatial variable is determined; the impulse response is the response to a normalized input pulse of duration tending to zero and with vertical rise and fall edges; an impulse response of similar form but compressed according to the scale of the variable in a ratio corresponding to a desired passband increase and expanded in amplitude in the same ratio is calculated sample by sample, and the coefficients of a finite impulse response filter able to provide at its output a succession of samples of the compressed response when a succession of corresponding samples of the response of the physical system is applied to its input are calculated. This finite impulse response filter is incorporated into the physical system, at output (preferably) or at input or inside the system, so as to improve the passband thereof in a ratio n.

Thus, a filter is sought which endows the corrected physical system with an impulse response of the same general form as its natural response but compressed according to the scale of the temporal or spatial variable and expanded in amplitude, rather than seeking a filter which attempts to fully compensate the transfer function of the physical system.

More precisely, the method according to the invention is a method for producing a system comprising a set of physical elements limiting the passband of the system, characterized in that the impulse response a(t) of the system is determined as a function of a variable t at least between a value 0 and a value T, at least N successive samples aᵢ of index i varying from 1 to N (N an integer greater than 1) are determined, the succession of which, distributed with a step T/N from the value t=T/N up to the value t=T, represents the form of the impulse response a(t), together with an arbitrary initial sample value a₀ and values of samples, possibly zero, approximately representing this curve between the instant T and an instant n·T where n is a coefficient representing a factor of desired passband increase, a curve b(t)=n·a(n·t) is determined, which curve is an approximate replica of the curve a(t), expanded in amplitude in the ratio n and compressed according to the scale of the variable t in the same ratio n, an initial sample value b₀=n·a0 is established and N samples bᵢ are taken, distributed with a step T/N from the value t=T/N up to the value t=T, and the succession of which represents this curve b(t), a finite impulse response filter with N+1 coefficients is produced, having an input and an output and able to provide on its output the successive values bᵢ from b₀ to b_{N} of the samples bᵢ when the successive samples aᵢ from a₀ to a_{N} are applied to its input, and this filter is incorporated into the system.

When the system is used thereafter, a passband signal improved in a factor n is gathered at the output of the corrected system.

The choice of the interval [0,T] is such that it encompasses the most relevant part of the impulse response a(t), for example the whole of the part of the response for which the amplitude of the response is greater than at least 5% of the maximum of the amplitude of the response. The samples included in the interval [T, nT] can very well be taken arbitrarily at zero, even if the values of a(t) are not zero in this interval, since these values are low; this possibly resulting in a worse result but an entirely acceptable result.

The coefficients of the filter are preferably coefficients Cᵢ where i is the index varying from 0 to N, the value of the coefficient Cᵢ being defined by the following iteration:

C₀=b₀/a₀ or a value preferably equal to n or close to n, and

Cᵢ=(bᵢ−aᵢ·C₀−aᵢ₋₁C₁ . . . −Cᵢ₋ⱼ·Cj . . . −a₁Cᵢ₋₁)/a₀,

If the value of the curve a(t) at time 0 is zero or close to zero, it is replaced with an arbitrary nonzero value a₀, preferably less than or equal to a₁, for example a₁/2.

In addition to the method, the invention relates to an electronic system comprising a set of physical elements whose nature induces a passband limitation of the system, and an electronic compensation filter making it possible to endow the system with a passband n times larger than that which the system would have without this filter, n being a number greater than 1, in which the system devoid of the filter possesses an impulse response a(t) as a function of a variable t, characterized in that the compensation filter is a finite impulse response filter with N+1 coefficients Cᵢ where i is an index varying from 0 to N, the value of the coefficient Cᵢ being defined by the following iteration:

C₀=b₀/a₀ and

Cᵢ=(bᵢ−aᵢ·C₀−aᵢ₋₁C₁ . . . −aᵢ₋ⱼ·Cj . . . −a₁Cᵢ₋₁)/a₀,

in which aᵢ is a sample value of index i varying from 1 to N taken from among N successive samples of the impulse response a(t) which are distributed with a step T/N between a value t=T/N and a value t=T, a₀ being replaced with a nonzero arbitrary value if a(t) is zero for t=0, and

in which bᵢ is a sample value equal to n times the value of a sample a_{n·i}=a(n·i·T/N) of the impulse response a(t).

Here again, if a₀ is zero, some other nonzero value, preferably lying between 0 and a₁, is chosen for a₀.

The factor n is preferably an integer. It is preferably equal to 2, 3 or 4.

It may also be non-integer and in this case the index n·i may not be an integer so that no sample a_{n·i} really exists. The dummy sample a_{n·i} which serves for the calculation of the sample bᵢ=n·a_{n·i} is then assigned a value interpolated between two real samples bracketing this dummy sample.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 symbolically represents a physical system receiving an input quantity e and providing an output quantity F(e);

FIG. 2 represents the impulse response F[x(t)] of the physical system;

FIG. 3 represents the principle of frequency-response compensation through an inverse transfer function in the frequency domain;

FIG. 4 represents the principle of establishing a desired impulse response on the basis of the real impulse response of the system;

FIG. 5 represents the principle according to the invention of correcting the passband through a finite impulse response filter associated with the physical system to be corrected;

FIG. 6 represents the general structure of a finite impulse response filter;

FIG. 7 represents the detail of the formulation of the desired impulse response b(t) on the basis of the natural response a(t) of the system;

FIG. 8 represents the frequency behavior of an uncorrected physical system in the presence of an input quantity e(t) in the form of notches of increasing frequency;

FIG. 9 represents the behavior of the corrected physical system, under the same conditions as in FIG. 8.

### DETAILED DESCRIPTION OF THE INVENTION

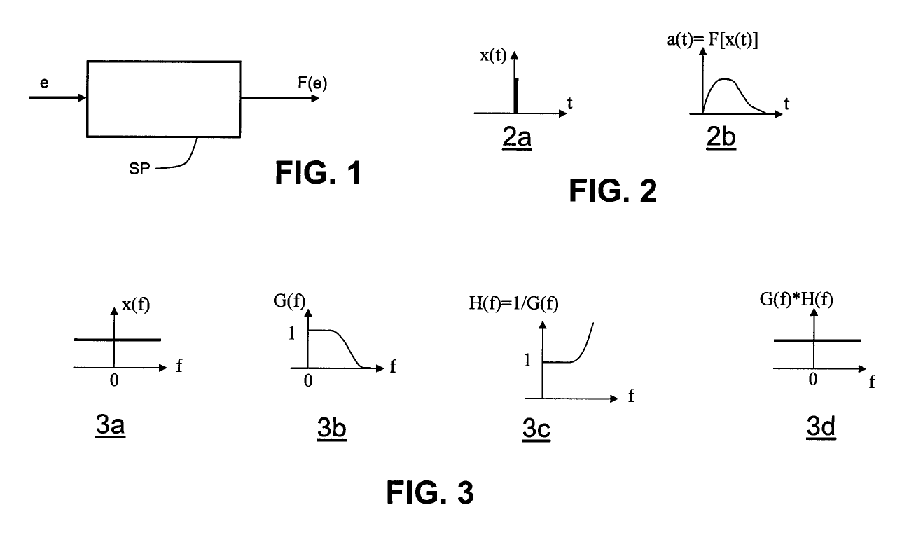

FIG. 1 represents in a symbolic form (a simple rectangle) an arbitrary physical system SP which, when an input quantity e is applied to it at input, provides an output quantity F(e) at output. For example, the input quantity e is an electronic signal and the output quantity F(e) is another electronic signal. Or else, the input quantity e is a luminance and the output quantity F(e) is an electronic signal, a luminance sensor being present in the system.

In many applications, it would be desirable for the system to behave in an ideal manner, that is to say for the quantity F(e) to vary according to a determined function of e both when e varies slowly and when e varies rapidly. For example it is desired that the light sensor produce an electronic signal of amplitude proportional to the luminance with the same proportionality coefficient when the luminance varies slowly and when it varies rapidly. But the system is a physical system and has limitations specific to any physical system, particularly limitations in ability to respond instantaneously to an instantaneous variation of the input quantity e. It introduces deformations of the function F(e) when e varies too rapidly.

When speaking here of rapid variation, it is necessary to understand that it is possible to speak of being rapid in time or in space. Indeed, it is necessary to consider the problems of limitation of physical systems both in terms of variation in time and variations in space as will be detailed further on.

Most of the time, physical systems behave as low-pass filters, that is to say they have a temporal or spatial passband that is limited above. Their temporal or spatial frequency-response curve is flat at low frequencies and then falls steeply beyond a certain frequency, whereas it would ideally be desirable for it to remain flat for much higher frequencies. But they can also have a passband that is limited both above and below, and even have a frequency-response curve which is not flat anywhere.

One way of representing the filter behavior of the physical system consists in determining its impulse response curve, that is to say applying a normalized Dirac pulse to the input of the system and observing the deformation of this pulse at the output of the system. Whatever the quality of the system, there is always a deformation. The curve of amplitude of response as a function of time (if the time is the variable concerned) or of a spatial variable is a representation of the general behavior of the physical system.

FIG. 2 represents at 2a the normalized input pulse (unit amplitude, duration tending to zero, vertical rise and fall edges), represented as a function x(t), and at 2b the impulse response a(t) of the system; the response a(t) is the curve F[x(t)] produced by the system when the input signal e=x(t) is applied to it. The variable considered for the impulse response is the time t but the reasoning would be the same if the variable was spatial; this is all the more true when the spatial variable can be referred to a temporal variable for example when the spatially varying signals are read sequentially. It will therefore be considered here and throughout what follows that the temporal variable term t is generic and is transposable directly or indirectly to a spatial variable.

In FIG. 3 this same impulse response has been represented in the frequency space, where the input pulse x(f) has a normalized spectrum uniform in amplitude over the whole of the band of positive and negative frequencies (FIG. 3a); the physical system is for example a low-pass filter (FIG. 3b) with function G(f) as a function of frequency, flat for the low frequencies, falling for the higher frequencies; it is then known how to plot a curve inverse to that of this filter, FIG. 3c, corresponding to an inverse transfer function H(f)=1/G(f). By placing in the physical system, upstream, downstream, or in the core of the system, a compensation filter having the transfer function H(f) in the frequency space, therefore a filtering curve like that of FIG. 3c, the transfer function of the overall system will be the product of the functions of the transfer of the physical system G(f) and of the transfer function of the filter H(f). This product (FIG. 3d) is equal to 1 and the normalized input pulse ought to be retrieved at the output of the system thus compensated.

The reality is not so simple since it is very difficult to produce such an inverse filter with transfer function H(f)=1/G(f) knowing only the form of the response curve G(f). Filtering can then be done through calculation by taking the Fourier transform at each instant of the electronic signal, inverting it, and taking the inverse Fourier transform, but this can only be done with very powerful and very fast processors.

According to the invention, the knowledge of the curve for the temporal (or spatial but, as has been stated, the principle is the same) impulse response of the physical system will be used to calculate a finite impulse response filter which will relate this impulse response to some other improved impulse response; the form of the improved response corresponds to a filtering function similar to that of the initial physical system but of wider passband.

The improved impulse response form is obtained by expanding the amplitude of the initial response a(t), whilst correspondingly compressing the time scale.

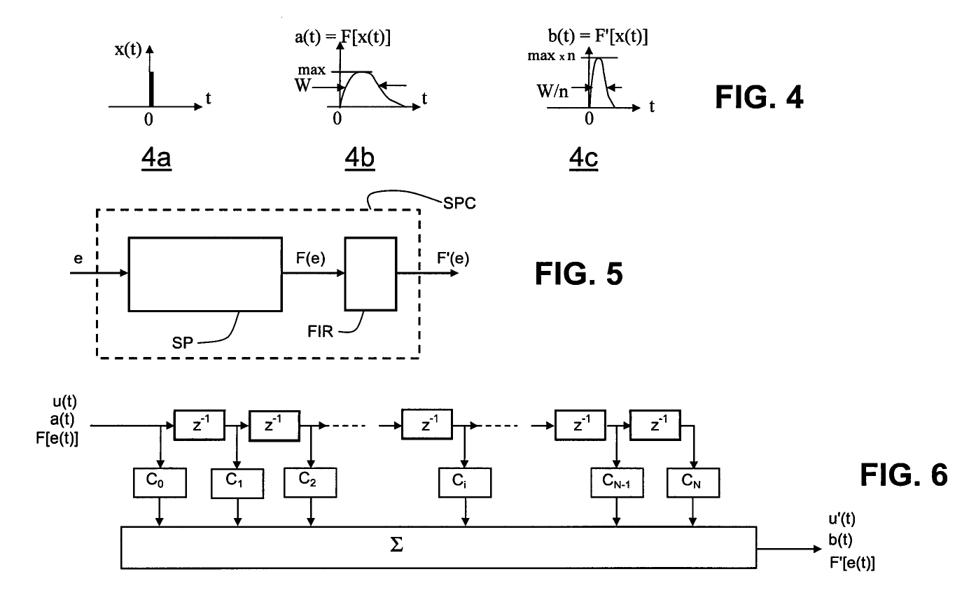

FIG. 4 represents at 4a the input pulse x(t) (as in FIG. 2a), at 4b the impulse response a(t) of the initial physical system (as in FIG. 2b), and at 4c a desired impulse response b(t), similar in form to that of FIG. 4b but compressed according to the time scale and expanded according to the amplitude scale. The width at mid-height of the response b(t) is that of the curve a(t) but divided by a factor n. The maximum height of the response b(t) is that of the curve a(t) but multiplied by n.

According to the invention, the impulse response of the physical system is therefore determined, an improved impulse response is deduced therefrom, this being a response similar to the initial response, expanded in amplitude and compressed according to the time scale, and the characteristics of a compensation filter which, when it receives the initial impulse response at its input, produces the improved impulse response at its output, are calculated. The filter is a finite impulse response filter whose coefficients are easy to calculate when the desired output response is known for a given form of input signal.

FIG. 5 represents the corrected physical system SPC whose impulse response is the impulse response of FIG. 4c. This system comprises the initial physical system SP and a finite impulse response FIR filter the function of which is to convert the waveform a(t) of FIG. 4b into the waveform b(t) of FIG. 4c, and by the same token to improve the passband of any waveform F(e) exiting the physical system SP.

The meaning of the term finite impulse response filter is recalled: it is a circuit which processes an analog signal sampled at a sampling frequency F, and which in a cyclic manner adds up a series of successive samples weighted by individual coefficients chosen as a function of the filtering function to be obtained. The number of samples in the series may be about ten or several tens, or indeed even several hundred according to the complexity of the filtering function to be produced. The sampling of the signal to be processed by the filter may be done in the filter or upstream of the filter depending on whether the physical system delivers unsampled or sampled signals.

FIG. 6 represents a finite impulse response filter. The signal to be filtered is a signal u(t), applied in the form of successive samples at the frequency F and the output signal from the filter is a signal u′(t) exiting in the form of samples. The filter is represented in the form of a set of delay circuits represented by the z⁻¹ boxes and of a set of multiplier circuits making it possible to apply to multiply the signal by a weighting coefficient Cᵢ specific to this circuit. The letter z is the variable conventionally serving for the mathematical representation of sampled systems and the function z⁻¹ represents a unit delay applied to a sample, therefore a delay 1/F if the sampling frequency is F.

The filter further comprises an adder ADD. As is readily understood by looking at FIG. 6, the output signal u′(t) from the filter is a sampled signal which is the weighted sum of the series of the N+1 latest successive samples received.

u′(t)=u₀·C₀+u₁·C₁+u₂·C₂+ . . . u_{N}·C_{N} if there are N+1 samples, counting the sample u₀. The successive samples u₀, u₁, u₂, etc up to u_{N} represent respectively the current sample u(t₀) at an instant t₀ and the previous samples u(t₀−dt), u(t₀−2dt), etc. up to u(t₀−N.dt).

The coefficients of the FIR filter are calculated according to the invention on the basis of the knowledge of the impulse response a(t) of the physical system SP. This impulse response is measurable or calculable on the basis of the known construction of the physical system. The calculation of the coefficients of the filter is done by determining which coefficients must be used in the filter in order for a sampled input signal having the form of the impulse response a(t) of FIG. 4b to exit the filter with the sampled form of the response b(t) of FIG. 4c.

The calculation will be set forth first in a simple example where it is desired to multiply the passband of the physical system SP by a number n, an integer greater than 1. Typically, n may be equal to 2 or 3. The figures which now follow refer to an example in which n is equal to 2.

A duration T over which the impulse response a(t) is relevant is considered; theoretically it extends to infinity, but in practice it always tends to zero, and the zone where it becomes very small is of no interest. By way of example, the duration T may be the duration for which the impulse response is at least equal to 5% of its maximum value.

This curve is sampled in steps of T/N, N being an arbitrarily chosen integer, which is all the higher the more finely it is desired to represent the impulse response b(t). N may be for example between 10 and 100, and a choice of N=15 or 31 or 63 is particularly indicated, so that the number N+1 is a power of two.

We denote by a₀, a₁, a₂, . . . aᵢ, . . . a_{N} the values of the impulse response at respective instants 0, T/N, 2T/N, etc. separated by time intervals equal to T/N, from the start (time zero) of the response (which is the instant of application of the normalized input pulse which gives rise to this response). The index i represents the sample number between 0 and N.

The values of these samples must be precisely measured or calculated since it is these samples which constitute the basis of the representation of the response of the physical system and also of the improved response as will be seen. The sample a₀ of index i=0 is processed differently as will be seen and is not necessarily equal to the value a(t) for t=0, in particular in the frequent case where this value is zero, so that the succession of samples of the curve a(t) between the instants t=0 and t=T may be considered to be composed of an arbitrary initial sample value a₀ and of N values of samples aᵢ whose succession represents the curve a(t).

Samples a_{n·i} of the curve a(t) between the time T and the time n·T are also determined. But the samples beyond the time T can also be set arbitrarily to zero since the tail of the impulse response, beyond the time T, is not relevant. These samples beyond the time T will be used to determine the improved impulse response, even if their value is zero.

A curve b(t), which is the desired improved impulse response, is constructed on the basis of the curve a(t).

In order for the curve b(t) to be an impulse response similar to the curve a(t) but expanded in amplitude in the ratio n and compressed in time in the same ratio n, it is necessary for the value b(t) at an instant t to be n times the value of the curve a(t) at the instant n·t.

Consequently, on the basis of a sample a_{n·i} which is the value of the curve a(t) at the instant t=n·i·T/N, a sample bᵢ which is the value of the curve b(t) at the instant i·T/N is established by taking as value bᵢ the value:

bᵢ=n·a_{n·i}

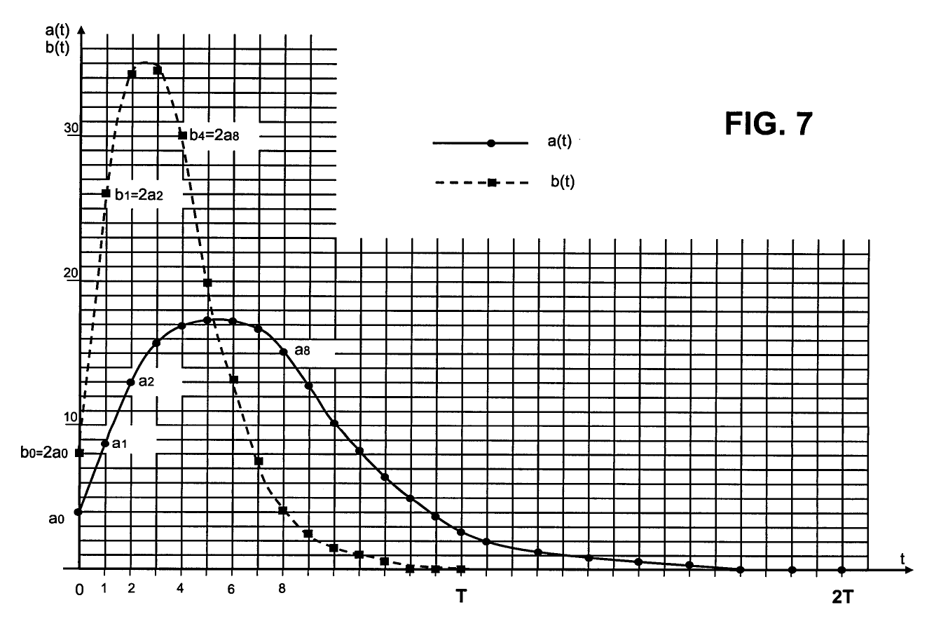

FIG. 7 illustrates this construction of the curve b(t) on the basis of samples of the curve a(t) in the case where n=2 and N=16. The initial response a(t), initially known, is shown solid; it comprises an arbitrary initial sample a₀ at the instant t=0 and N samples between T/N and T and other samples between T and nT, these possibly being set to zero optionally; the improved response b(t) is shown dashed: it is a curve established by smoothing on the basis of the N+1 samples bᵢ calculated according to the formula above.

The coefficients of the finite impulse response filter which makes it possible to obtain the response b(t) at its output when a signal whose temporal variation is that of the response a(t) is applied to its input, are calculated on the basis of the samples aᵢ and bᵢ. When such a filter is used subsequently by applying to it, no longer a signal a(t), but a signal F[e(t)] originating from the output of the physical system, this filter will deliver a signal F′[e(t)] with a passband improved in the ratio n.

The calculation of the coefficients C₀, C₁, . . . Cᵢ, . . . C_{N} of the filter is an iterative calculation relying on the fact that the output b(t) from the filter is dependent on the series of successive samples aᵢ applied to the input:

b(t)=a₀·C₀+a₁·C₁+a₂·C₂+ . . . a_{N}·C_{N}

Before the instant 0, the input samples are all zero. This results in the following equalities:

b₀=a₀·C₀+0+0+0 . . . +0

b₁=a₁·C₀+a₀·C₁+0+0 . . . +0

. . .

bᵢ=aᵢ·C₀+aᵢ₋₁·C₁+ . . . +a₀·Cᵢ+0 . . . +0

. . .

bₙ=aₙ·C₀+aₙ₋₁·C₁+ . . . a₀·Cₙ

and consequently:

C₀=b₀/a₀ this value is in principle equal to n on account of the expansion of the curve in the ratio n. It is because it would not be possible to calculate b₀/a₀ if a₀ were zero or too close to zero that the sample a₀ is then given an arbitrary value or that the value C₀=n (or if strictly necessary a value close to n) is quite simply chosen for the first coefficient of the filter without even needing to choose a sample value a₀.

C₁=(b₁−a₁·C₀)/a₀=(2·a₂−a₁·C₀)/a₀ in the case where n=2 according to the formula bᵢ=n·a_{n·i}

. . .

Cᵢ=(n·a_{n·i}−aᵢ·C₀−aᵢ₋₁·C₁ . . . −a₁·Cᵢ₋₁)/a₀

. . .

C_{N}=(n·a_{n·N}−a_{N}·C_{O}−a_{N-1}·C₁ . . . −a₁·C_{N-1})/a₀

It is recalled that for this calculation the samples aᵢ beyond the time T may be arbitrarily taken as zero if one does not wish to use the real samples of the curve a(t) which, anyway, are small since the relevant part of the response lies between the instants 0 and T.

It may happen that the value of the curve a(t) at the instant t=0 is zero or very close to zero. In this case, the sample value a₀ will be forced to a value different from zero, for example to the value a₁/2 which is an intermediate value between 0 and a₁. And furthermore b₀ will be taken equal to n times the forced value of a₀ to keep the ratio b₀/a₀ equal to n.

This leads to a finite impulse response compensation filter with N+1 coefficients which increases in a factor n the passband of the initial physical system. During operation, this filter receives the output F[e(t)] of the physical system whose passband one wishes to increase, and it provides an output F′[e(t)] with increased passband. It would be possible also to envisage the compensation FIR filter being placed in the physical system rather than at its output, that is to say it is optionally possible to place the filter upstream of the physical elements which tend to reduce the passband.

In the foregoing n has been considered to be an integer, preferably equal to 2 or 3 or 4. It would be possible also to envisage n being a non-integer value, for example 2.5 or 3.5 (or indeed any number although in practice this is of little interest).

The same principle of establishing a curve b(t) corresponding to the curve a(t) but expanded in amplitude by a factor n and compressed in time by the same factor n is retained. The difference resides in the obtaining of the samples bᵢ which will serve to construct the curve b(t) and which will serve in the calculation of the coefficients of the filter.

Values of samples a_{n·i} are no longer available when n·i is not an integer. In this case, it will be possible to use as sample value a_{n·i} a value interpolated between the two real samples closest to the non-existent sample of rank n·i.

For example, if n=2.5 and i=3, a dummy sample a_{7.5} will be established which will be an interpolation between the sample a₇ and the sample a₈, for example simply the mean a_{7.5}=(a₇+a₈)/2 of the two adjacent known samples. Consequently, in this example, we will find b₃=2.5(a₇+a₈)/2 and, in the calculation of the coefficients of the filter, the values of known samples of rank i=0 to N will be used for the samples aᵢ as for the samples bᵢ.

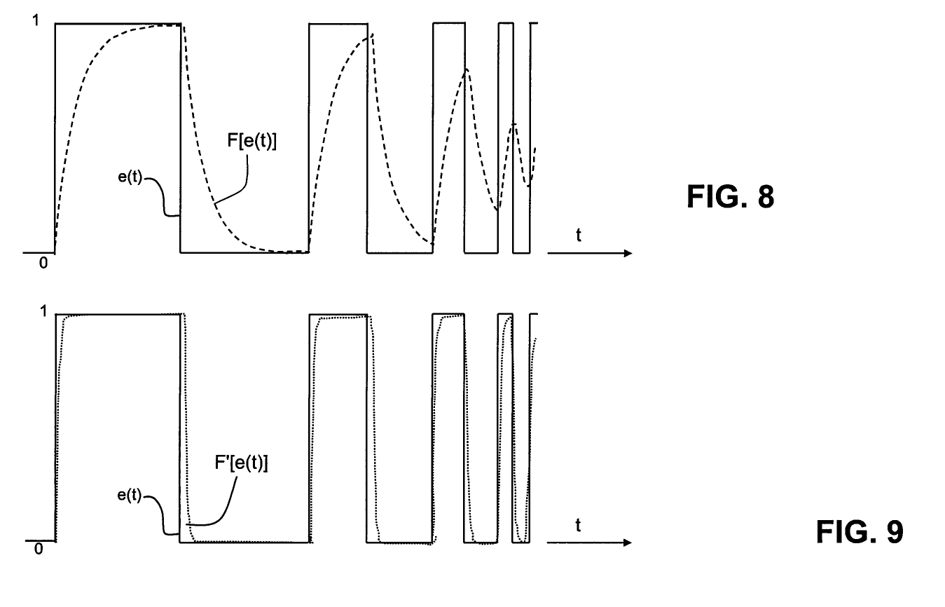

FIG. 8 represents a simulation performed for a physical system SP whose transfer function is regarded as a first-order low-pass filter. A rectangular notch input waveform (shown solid), at a frequency which is greater than a cutoff frequency of the filter and which varies over time (the duration of the notches keeps decreasing), is applied as quantity e(t) to the input of the physical system SP. The output of the system is a quantity F[e(t)] which is represented by a dashed curve. On account of the low-pass filtering, it is seen that the output does not succeed in faithfully following the edges of the notch-like variations.

FIG. 9 represents the output F′[e(t)] of the system corrected by the FIR filter calculated in the manner explained previously, the same notches e(t) being applied to the input. It is seen that this output follows the notches much better and deteriorates only for the briefest notches.

The FIR filter which serves in the example of FIG. 9 has been calculated for n=10, with N=15 (filter with 16 coefficients). The calculated coefficients are as follows:

C₀ = 10
C₁ = −6.376
C₂ = −1.422
C₃ = −0.317
C₄ = −0.070
C₅ = −0.0158
C₆ = −0.00353
C₇ = −0.000786
C₈ = −0.0000176
C₉ = −3.917 × 10⁻⁵
C₁₀ = −8.741 × 10⁻⁶
C₁₁ = −1.950 × 10⁻⁶
C₁₂ = −4.352 × 10⁻⁷
C₁₃ = −9.710 × 10⁻⁸
C₁₄ = −2.167 × 10⁻⁸
C₁₅ = −4.835 × 10⁻⁹

This filter is given merely by way of illustrative example clearly showing the considerable improvement that can be obtained in the passband. In practice the physical system will not be as simple as a first-order filter, the number of coefficients N of the filter will rather be 32 or 64 and the passband increase factor n will rather be between 2 and 4.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of increasing the passband of a physical system comprising a set of physical elements limiting the passband of the system, wherein the impulse response a(t) of the physical system is determined as a function of a temporal or spatial variable t between values t=0 and t=T of the variable, an impulse response of similar form but compressed according to the scale of the variable in a ratio n corresponding to a desired passband increase and expanded in amplitude in the same ratio n is calculated sample by sample, the coefficients of a finite impulse response filter able to provide at its output a succession of samples of the compressed response when a succession of corresponding samples of the response of the physical system is applied to its input are determined, and this finite impulse response filter is incorporated into the physical system.

2. The method as claimed in claim 1, wherein at least N successive samples aᵢ of index i varying from 1 to N (N an integer greater than 1) are determined, the succession of which, distributed with a step T/N from the value t=T/N up to the value t=T, represents the form of the impulse response a(t), together with an arbitrary initial sample value a₀ and values of samples, possibly zero, approximately representing this curve between the instant T and an instant n·T where n is a coefficient representing a factor of desired passband increase, a curve b(t)=n·a(n·t) is determined, which curve is an approximate replica of the curve a(t), expanded in amplitude in the ratio n and compressed according to the scale of the variable t in the same ratio n, an initial sample value b₀=n·a0 is established and N samples bᵢ are taken, distributed with a step T/N from the value t=T/N up to the value t=T, and the succession of which represents this curve b(t), and wherein the finite impulse response filter is a filter with N+1 coefficients, having an input and an output and able to provide on its output the successive values bᵢ from b₀ to b_{N} of the samples bᵢ when the successive samples aᵢ from a₀ to a_{N} are applied to its input.

3. The method as claimed in claim 2, wherein the coefficients of the filter are coefficients Cᵢ where i is the index varying from 0 to N, the value of the coefficient Cᵢ being defined by the following iteration:
C₀=b₀/a₀ or a value close to n, and
Cᵢ=(bᵢ−aᵢ·C₀−aᵢ₋₁·Cj . . . −a₁Cᵢ₋₁)/a₀,

4. The method as claimed in claim 1, wherein the value a₀ chosen as first sample value to calculate the coefficients is chosen equal to a value lying between the value of a(t) for t=0 and the value of the second sample a₁ in the case where a(t) for t=0 is a value which is zero or close to zero.

5. The method as claimed in claim 2, wherein n is chosen between 2 and 4.

6. The method as claimed in claim 2, wherein n is an integer.

7. The method as claimed in claim 1, wherein n is not an integer and the values of samples a_{n·i} of non-integer index n·i are values interpolated between neighboring samples of integer index.

8. An electronic system comprising a set of physical elements whose nature induces a passband limitation of the system, and an electronic compensation filter making it possible to endow the system with a passband n times larger than that which the system would have without this filter, n being a number greater than 1, in which the system devoid of the filter possesses an impulse response a(t) as a function of a variable t, wherein the compensation filter is a finite impulse response filter with N+1 coefficients Cᵢ where i is an index varying from 0 to N, the value of the coefficient Cᵢ being defined by the following iteration:
C₀=b₀/a₀ or a value close to n
Cᵢ=(bᵢ−aᵢ·C₀−aᵢ₋₁C₁ . . . −aᵢ₋₁·Cj . . . −a₁Cᵢ₋₁)/a₀,
in which a₀ is an arbitrary value, aᵢ is a sample value of index i taken from among N successive samples of the impulse response a(t) which are distributed with a step T/N between a value t=T/N and a value t=T, and
in which b₁ is a sample value equal to n times the value of a sample a_{n·i}=a(n·i·T/N) of the impulse response a(t).

9. The electronic system as claimed in claim 8, wherein the value chosen for a₀ in the iteration is equal to a value lying between the value of a(t) for t=0 and the value of the second sample a₁ in the case where a(t) for t=0 is a value which is zero or close to zero.

10. The system as claimed in claim 9, wherein the factor n is an integer preferably equal to 2, 3 or 4.

11. The system as claimed in claim 9, wherein n is not an integer and the values of samples aₙ, of non-integer index n·i are values interpolated between neighboring samples of integer index.
